(19) United States
(12) Patent Application Publication
(10) Pub. No.: US 2017/0221075 A1
(43) Pub. Date: Aug. 3, 2017

(54) FRAUD INSPECTION FRAMEWORK

(71) Applicant: SAP SE, Walldorf (DE)

(72) Inventors: Mengjiao WANG, Shanghai (CN); Wen-Syan LI, Shanghai (CN)

(21) Appl. No.: 15/009,847

(22) Filed: Jan. 29, 2016

(51) Int. Cl. G06Q 30/00; G06N 99/00; G06F 17/30

(52) U.S. Cl. CPC G06Q 30/0185; G06F 17/30442; G06N 99/005

(57) ABSTRACT

Described herein is a framework to facilitate fraud inspection. In accordance with one aspect of the framework, one or more fraud rules are generated based on the historical data by performing machine learning. The one or more fraud rules are applied to select records from input records for physical inspection. The selected records may then be transmitted to one or more output devices to initiate physical inspection for fraud.

### TECHNICAL FIELD

The present disclosure relates generally to computer systems, and more specifically, to a framework for fraud inspection.

### BACKGROUND

Fraud generally refers to a false representation of a matter of fact (e.g., by false declaration or concealment) to secure unfair or unlawful gain. There is an increasing interest in automatic fraud detection in areas such as anti-money laundering and anti-tax evasion. Physical monitoring to detect fraud is typically very time-consuming and capital intensive. Due to the practical difficulties in inspecting for fraudulent behavior, customs officers usually only select, based on their working experiences, a very small number of declaration forms for checking.

However, the accuracy of fraud detection based on human experience is neither high nor stable. Corruption (e.g., bribery) of officers is unavoidable particularly in the absence of proper regulations to limit such behavior. Typically, only a small number of suspected fraud instances are investigated so as to control the cost of inspection. Thus, some fraud instances will go undetected.

### SUMMARY

A framework for fraud inspection is described herein. In accordance with one aspect of the framework, one or more fraud rules are generated based on the historical data by performing machine learning. The one or more fraud rules are applied to select records from input records for physical inspection. The selected records may then be transmitted to one or more output devices to initiate physical inspection for fraud.

With these and other advantages and features that will become hereinafter apparent, further information may be obtained by reference to the following detailed description and appended claims, and to the figures attached hereto.

### BRIEF DESCRIPTION OF THE DRAWINGS

Some embodiments are illustrated in the accompanying figures, in which like reference numerals designate like parts, and wherein:

FIG. 1 is a block diagram illustrating an exemplary architecture;

FIG. 2 shows an exemplary method for fraud inspection;

FIG. 3 shows an exemplary decision tree; and

FIG. 4 shows an exemplary optimization procedure.

### DETAILED DESCRIPTION

In the following description, for purposes of explanation, specific numbers, materials and configurations are set forth in order to provide a thorough understanding of the present frameworks and methods and in order to meet statutory written description, enablement, and best-mode requirements. However, it will be apparent to one skilled in the art that the present frameworks and methods may be practiced without the specific exemplary details. In other instances, well-known features are omitted or simplified to clarify the description of the exemplary implementations of the present framework and methods, and to thereby better explain the present framework and methods. Furthermore, for ease of understanding, certain method steps are delineated as separate steps; however, these separately delineated steps should not be construed as necessarily order dependent in their performance.

A framework for fraud inspection is described herein. One aspect of the present framework combines machine learning and random sampling to obtain more robust inspection results. In some implementations, the framework learns from historical fraud inspection records and builds an expert system to generate new human-readable fraud detection rules. The framework then evaluates the rules with historical data to determine their accuracies. The framework may optimize physical inspection by applying the generated rules to select candidate fraud instances to investigate. The optimization may ensure that the income and outcome of the inspection are balanced, and that the required inspection resources are within the currently available capacity.

For purposes of illustration, the present framework may be described in the context of fraud in customs checking. For example, the present framework may be applied to detect false claims in declaration forms submitted for goods being imported or exported via a transportation terminal (e.g., port, airport, border, etc.). A large number of customs declaration forms may be submitted each day, and customs officers have to find the false declaration forms out of all these declaration forms. The inspection procedure generates cost (e.g., machine cost, chemical test cost, personnel salaries, etc.) regardless of what the checking result is. The fine should be balanced with the costs of inspection during optimization.

It should be appreciated, however, that other types of fraud instances (e.g., money laundering, fraudulent online transactions, etc.) may also be detected by the present framework. The framework described herein may be implemented as a method, a computer-controlled apparatus, a computer process, a computing system, or as an article of manufacture such as a computer-usable medium. These and various other features and advantages will be apparent from the following description.

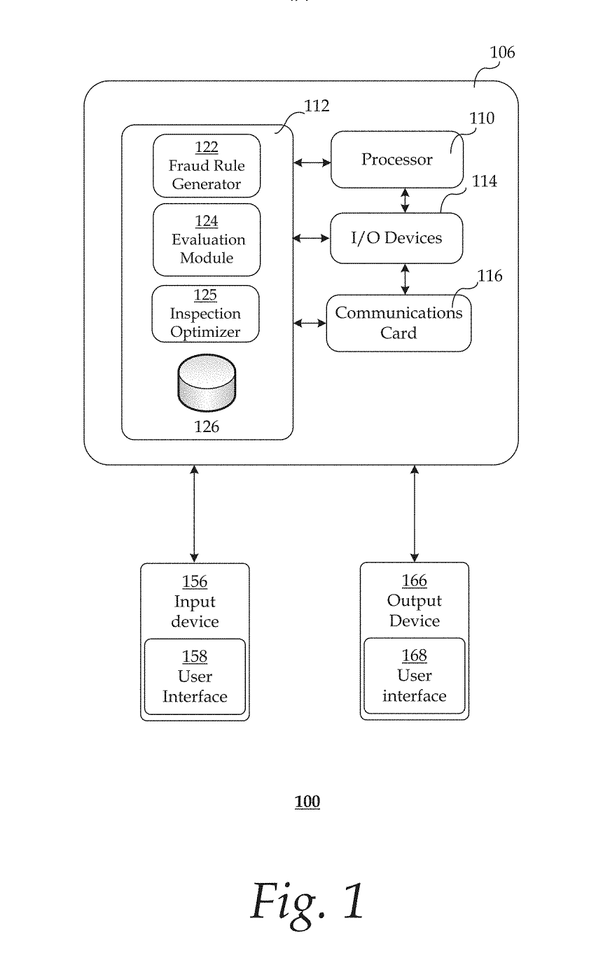

FIG. 1 is a block diagram illustrating an exemplary architecture 100 in accordance with one aspect of the present framework. Generally, exemplary architecture 100 may include a server 106, an input device 156 and an output device 166.

Server 106 is capable of responding to and executing machine-readable instructions in a defined manner. Server 106 may include a processor 110, input/output (I/O) devices 114 (e.g., touch screen, keypad, touch pad, display screen, speaker, etc.), a memory module 112 and a communications card or device 116 (e.g., modem and/or network adapter) for exchanging data with a network (e.g., local area network or LAN, wide area network (WAN), Internet, etc.). It should be appreciated that the different components and sub-components of server 106 may be located or executed on different machines or systems. For example, a component may be executed on many computer systems connected via the network at the same time (i.e., cloud computing).

Memory module 112 may be any form of non-transitory computer-readable media, including, but not limited to, dynamic random access memory (DRAM), static random access memory (SRAM), Erasable Programmable Read-Only Memory (EPROM), Electrically Erasable Programmable Read-Only Memory (EEPROM), flash memory devices, magnetic disks, internal hard disks, removable disks or cards, magneto-optical disks, Compact Disc Read-Only Memory (CD-ROM), any other volatile or non-volatile memory, or a combination thereof. Memory module 112 serves to store machine-executable instructions, data, and various software components for implementing the techniques described herein, all of which may be processed by processor 110. As such, server 106 is a general-purpose computer system that becomes a specific-purpose computer system when executing the machine-executable instructions. Alternatively, the various techniques described herein may be implemented as part of a software product. Each computer program may be implemented in a high-level procedural or object-oriented programming language (e.g., C, C++, Java, JavaScript, Advanced Business Application Programming (ABAP™) from SAP® AG, Structured Query Language (SQL), etc.), or in assembly or machine language if desired. The language may be a compiled or interpreted language. The machine-executable instructions are not intended to be limited to any particular programming language and implementation thereof. It will be appreciated that a variety of programming languages and coding thereof may be used to implement the teachings of the disclosure contained herein.

In some implementations, memory module 112 includes fraud rule generator 122, evaluation module 124, inspection optimizer 125 and database 126. Fraud rule generator 122 may learn from historical inspection records from input device 156 and generate human-readable rules based on, for example, a decision tree. Evaluation module 124 may evaluate the generated fraud rules and filter out rules with low accuracy or high hit rates. Inspection optimizer 125 may apply the remaining rules to a real-time input record stream and select candidate records to investigate under the constraint of resource capacity. Inspection optimizer 125 may also randomly sample records from the real-time stream for investigation. The selected records are forwarded to output device 166 to initiate physical inspection.

Server 106 may operate in a networked environment using logical connections to one or more input devices 156 and one or more output devices 166. Such input and output devices (156, 166) are capable of responding to and executing machine-readable instructions in a defined manner. Input and output devices (156, 166) may include user interfaces (e.g., graphical user interfaces) (158, 168) to access information and services provided by server 106. Input and output devices (156, 166) may also include other components (not shown), such as a processor, non-transitory memory, I/O devices, communications card, etc. It should be appreciated that one or more components of the input and/or output devices (156, 166) may also be implemented in server 106. Alternatively, or additionally, one or more components of server 106 may be implemented in input and/or output devices (156, 166).

Input device 156 serves to provide records to server 106 for processing (e.g., fraud inspection, learning, etc.). In some implementations, input device 156 provides access to a historical inspection database that stores historical data. Input device 156 may also provide a real-time stream of records (e.g., declaration forms) provided by importers and/or exporters. Output device 166 may serve to receive and present (via user interface 168) the fraud inspection results from the server 106. Output device 166 may initiate physical checking of suspicious records identified by server 106.

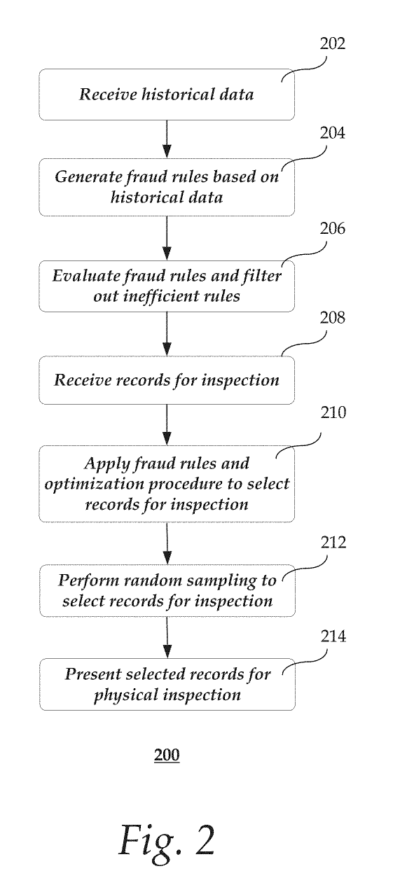

FIG. 2 shows an exemplary method 200 for fraud inspection. The method 200 may be performed automatically or semi-automatically by the system 100, as previously described with reference to FIG. 1. It should be noted that in the following discussion, reference will be made, using like numerals, to the features described in FIG. 1.

At 202, fraud rule generator 122 receives historical data. The historical data may be transmitted from, for example, the historical inspection database stored in input device 156. In some implementations, the historical data include customs declaration forms from importers and/or exporters of goods, related declaration form information, inspection methods, inspection results, fine amounts, and so forth. Each declaration form may include many data field values, such as form unique identifier (id), declared goods information (e.g., name, type, quantity, size), owner information (e.g., name, address), agent information (e.g., name, address), declared value of goods, tax rate, and so on. The amount of fine is usually a numeric value, and may be discretized into different categories with different ranges of fine amounts, such as ZERO, LOW, MEDIUM, HIGH and VERY HIGH. It should be appreciated that other types of records may also be received for inspecting other types of fraud instances.

At 204, fraud rule generator 122 generates one or more fraud rules based on the historical data. In some implementations, fraud rule generator 122 performs machine learning by training one or more decision trees based on the historical data. A decision tree generally maps observations about an item to conclusions about the item's target value. One type of decision tree is the Classification and Regression Tree (CART). Other types of decision trees, such as a random forest or binary decision diagram, may also be used.

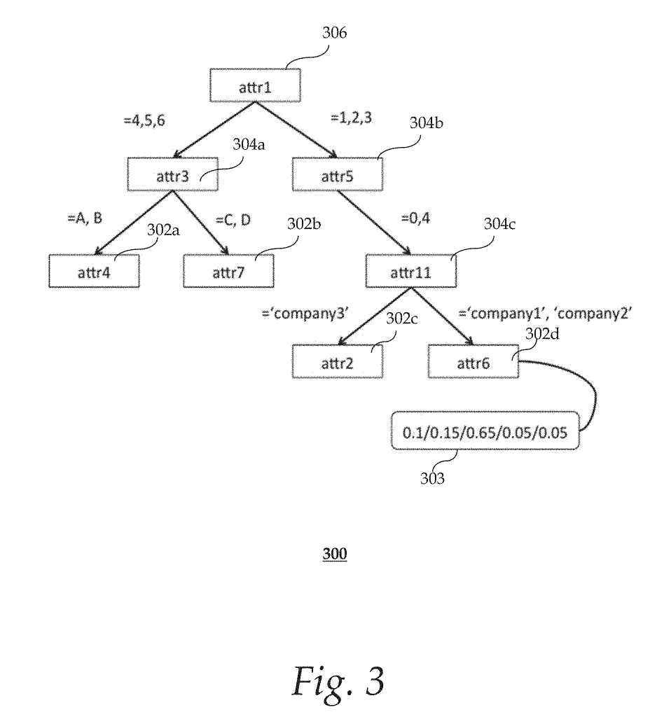

FIG. 3 shows an exemplary decision tree 300. Each internal (non-leaf) node (304a-c) denotes a test on an attribute (e.g., attr3, attr5, attr11). The attributes may correspond to the data fields of a record (e.g., declaration form), such as form id, declared goods information, owner information, agent information, declared value of goods, tax rate, and so forth. Each branch represents the outcome of a test (e.g., =A or B) and each leaf (or terminal) node (302a-d) holds a class label. The topmost node 306 is the root node. Each leaf node (302a-d) is associated with a probability table. The probability table stores probabilities corresponding to different result categories, such as different ranges of fine: ZERO, LOW, MEDIUM, HIGH and VERY HIGH. The class label for the leaf node (302a-d) is the name of the category with the highest probability. For example, leaf node 302d is associated with a probability table 303, which stores the following probabilities: ZERO—0.1, LOW—0.15, MEDIUM—0.65, HIGH—0.05, VERY HIGH—0.05. The class label for this leaf node 302d will be MEDIUM with probability of 0.65.

To extract fraud rules from the decision tree 300, a bottom-up search technique may be used. For example, if rules associated with attr6 (302d) are to be extracted, the technique first starts with the parent node (304c) of attr6, which is attr11=‘company1’ or ‘company2’, and then goes up to the parent node (304b) of attr11, which is attr5=0 or 4, and then goes up to the parent node (306) of attr5, which is attr1=1 or 2 or 3. The rules generated with this leaf node are as follows:

attr11=‘company1’ or ‘company2’ (1)

attr5=0 or 4 (2)

attr1=1 or 2 or 3 (3)

Fine=MEDIUM (4)

Accordingly, the bottom-up search technique keeps going up the levels and extracting rules until it reaches the root of the decision tree 300. This technique may be applied to each leaf node (302a-d) until all fraud rules are derived.

For historical inspection records with many data fields, the decision tree can be very large and contain many leaf nodes, thereby making the search very complex and computationally intensive. To filter out leaf nodes with very low probabilities, a predetermined threshold may be used. For example, setting the threshold to 0.6 enables the search technique to consider only leaf nodes with probability accuracies higher than 0.6.

Returning to FIG. 2, at 206, evaluation module 124 evaluates the one or more generated fraud rules. In some implementations, instead of using the entire set of historical data to train the decision tree in the previous step 204, only a subset of the historical data is used for training. The remaining historical data may be used to validate the generated fraud rules.

To evaluate a generated fraud rule, the fraud rule may be applied to the remaining historical data to determine the accuracy of this rule (e.g., determine what percentage of the declaration forms that match this rule were actually fined). The accuracy may be a percentage value calculated as follows:

$$accuracy = \frac{n}{N} \times 100 \% \qquad ( 5 )$$

wherein n is the number of forms that were actually fined and N is the total number of forms that match the given rule.

Another important key performance indicator (KPI) of a rule that may be determined is the number of matches found in the historical data. If a rule matches too many historical declaration forms (e.g., >50%), this rule should not be applied to optimize inspection. Threshold values may be applied to filter out rules that have an accuracy that is less than a first predetermined threshold value and number of matches that is more than a second predetermined threshold value. The remaining final rules may then be used for optimizing inspection.

At 208, inspection optimizer 125 receives input records from input device 156 for inspection. In some implementations, the input records are provided by the input device in a substantially real-time stream. For example, the substantially real-time stream may include customs declaration forms submitted by parties (e.g., companies) who wish to import or export goods into a country. The forms may be submitted to comply with reporting requirements for customs purposes.

At 210, inspection optimizer 125 applies the one or more fraud rules and an optimization procedure to select records for physical inspection. Since physical inspection is resource-intensive, not all the received records can feasibly be investigated. The generated fraud rules are applied to select a subset of records from the substantially real-time stream that satisfy or match the rules. A query statement (e.g., Structured Query Language or SQL statement) may be constructed from the generated fraud rule to select the subset of records. An exemplary query statement is shown as follows:

SELECT*FROM D_FORM WHERE attr11 IN (‘company1’, ‘company 2’) AND attr5 IN (0,4) AND attr1=IN (1,2,3) AND check_flag=FALSE (6)

The subset of records may further be reduced by performing an optimization procedure that balances the potential income and cost of inspection, and to ensure that the required inspection resources do not exceed the currently available capacity.

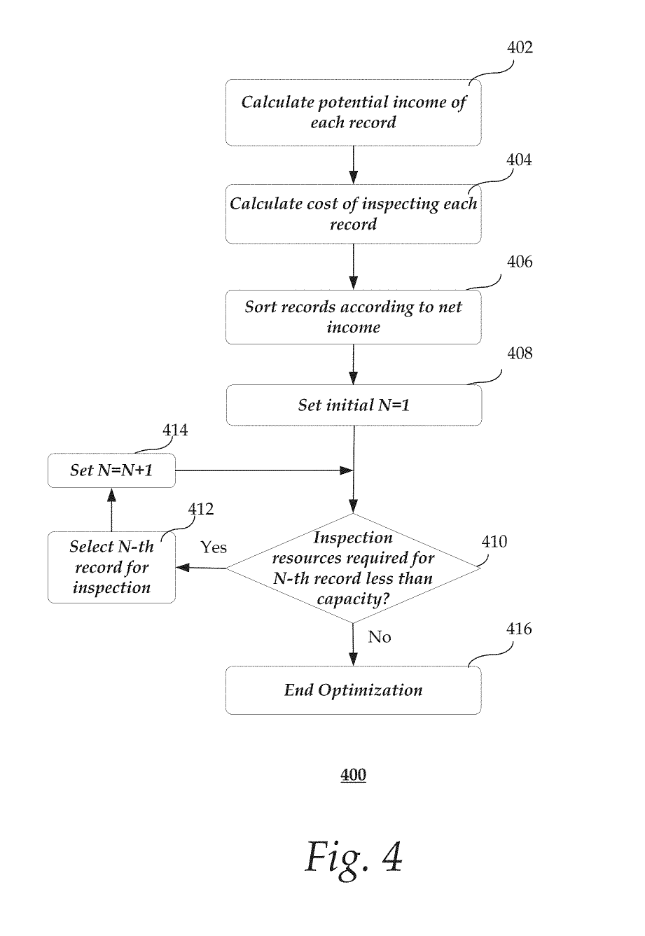

FIG. 4 shows an exemplary optimization procedure 400. At 402, inspection optimizer 125 calculates the potential income of each record (e.g., declaration form). In some implementations, the potential income is calculated based on the amount of fine that may be imposed when a fraud is detected. The potential income for the record that matches a related rule can be calculated as follows:

income=prob*value (7)

wherein prob is the probability of the rule and value is the median value of the lower and upper boundaries of the related class label (e.g., MEDIUM). As discussed previously, the amount of fine may be discretized into different ranges. For example, MEDIUM fine may be defined as USD 10,000 to 20,000. The value will thus be (10,000+20,000)/2. The potential income will then be 0.65*(10,000+20,000)/2=USD 9,750.

At 404, inspection optimizer 125 calculates the cost of inspecting each record. The cost of inspection may include manpower wages, the cost of any chemical test and/or equipment required for inspection, etc.

At 406, inspection optimizer 125 sorts the records according to net income to generate a sorted list of records. The net income is determined by potential income minus cost. The records may be sorted in, for example, descending order of the net income.

At 408, inspection optimizer 125 initiates a greedy optimization algorithm to process the records from top to bottom of the sorted list. More particularly, the index N is first initialized to 1 to process the record with the greatest net income. At 410, inspection optimizer 125 checks the N-th record in the sorted list to determine if the resources required to inspect the N-th record are less than (or do not exceed) the available capacity. Such resources may include, for example, the number of people and equipment required for inspection. If the resources do not exceed the available capacity, the N-th record is selected for physical inspection at 412 and the next record in the sorted list is processed at 414. If not, the optimization ends at 416. The records selected by such optimization may then be transmitted to the output device 166 for physical inspection.

Returning to FIG. 2, at 212, inspection optimizer 125 performs random sampling to select additional records from the received records for inspection. Random sampling may be performed to select a small portion of the received records to ensure the inspection results are more robust. The records selected by random sampling may be directly transmitted to the output device 166 for physical inspection.

A 214, output device 166 receives selected records from the inspection optimizer 125 and presents the records for physical inspection. In some implementations, the records are displayed in a visualization generated by user interface 168. Output device 166 may also initiate printing of hard copies of the selected records. Other types of presentation may also be provided to initiate physical inspection for fraud.

Physical inspection may be performed by, for example, a customs officer. For example, if an import or export declaration form is suspected of false claims, the customs officer have to first locate the container where the declaration form is related to in a port, and open the container to perform a physical checking of the goods stored therein to determine if the actual goods match the claims in the declaration form. Sometimes, a chemical test is further performed to confirm whether or not the goods described in the declaration form are legal. The false claims in the declaration forms may include, but are not limited to, the declared goods being different from the actual goods being imported or exported, the declared weight of the goods being smaller than the actual weight, the importer or exporter of the goods having no permission to import or export the goods, and so forth. Such false claims may be submitted to evade taxes or smuggle banned goods. The owner of the goods will be fined if customs officers confirm the false claims by physical checking; otherwise, the goods will be released by the customs.

Although the one or more above-described implementations have been described in language specific to structural features and/or methodological steps, it is to be understood that other implementations may be practiced without the specific features or steps described. Rather, the specific features and steps are disclosed as preferred forms of one or more implementations.

1. A fraud inspection system, comprising:
one or more input devices that provide historical data and input records;
a non-transitory memory device for storing computer-readable program code; and
a processor in communication with the memory device and the one or more input devices, the processor being operative with the computer-readable program code to
generate one or more fraud rules based on the historical data by performing machine learning,
apply the one or more fraud rules and an optimization procedure to select first records from the input records,
perform random sampling to select second records from the input records, and
transmit the first and second records to one or more output devices to initiate physical inspection for fraud.

2. The system of claim 1 wherein the input records comprise customs declaration forms from importers or exporters of goods.

3. The system of claim 1 wherein the historical data comprises customs declaration forms and associated fine amounts.

4. A method of fraud inspection, comprising:
receiving historical data and input records from one or more input devices;
generating one or more fraud rules based on the historical data by performing machine learning;
selecting records from the input records by applying the one or more fraud rules; and
transmitting the selected records to one or more output devices to initiate physical inspection for fraud.

5. The method of claim 4 wherein generating the one or more fraud rules comprises training one or more decision trees.

6. The method of claim 5 wherein training the one or more decision trees comprises training a Classification and Regression Tree (CART).

7. The method of claim 6 wherein training the Classification and Regression Tree (CART) comprises associating a leaf node of the CART to probabilities of different ranges of fine.

8. The method of claim 6 further comprises extracting the one or more fraud rules by performing a bottom-up search technique from a leaf node to a root node of the CART.

9. The method of claim 8 wherein performing the bottom-up search technique comprises performing the bottom-up search technique from a leaf node associated with a probability accuracy higher than a predetermined threshold value.

10. The method of claim 4 further comprises:
filtering out one or more inefficient rules from the one or more fraud rules to generate a set of one or more final fraud rules to select the records from the input records.

11. The method of claim 10 wherein filtering out the one or more inefficient rules comprises filtering out one or more rules with an accuracy that is less than a predetermined threshold value.

12. The method of claim 10 wherein filtering out the one or more inefficient rules comprises filtering out one or more rules with a number of matches that is more than a predetermined threshold value.

13. The method of claim 4 wherein selecting the records further comprises performing an optimization procedure that balances potential income and cost of inspection to select records from records that match the one or more fraud rules.

14. The method of claim 13 wherein the optimization procedure further ensures that resources required to inspect the selected records do not exceed capacity.

15. The method of claim 13 further comprises calculating the potential income based on an amount of fine and a probability of a related rule.

16. The method of claim 13 further comprises calculating the cost of inspection based on manpower wages and cost of equipment or test.

17. The method of claim 4 further comprises performing random sampling to select additional records from the input records for physical inspection.

18. A non-transitory computer-readable medium having stored thereon program code, the program code executable by a computer to perform steps comprising:
receiving historical data and input records from one or more input devices;
generating one or more fraud rules based on the historical data;
selecting records from the input records by applying the one or more fraud rules; and
transmitting the selected records to one or more output devices to initiate physical inspection for fraud.

19. The non-transitory computer-readable medium of claim 18 wherein the program code is executable by the computer to generate the one or more fraud rules by training one or more decision trees.

20. The non-transitory computer-readable medium of claim 18 wherein the program code is executable by the computer to select the records by performing an optimization procedure that balances potential income and cost of inspection to select records from records that match the one or more fraud rules.
